(19) United States
(12) Patent Application Publication
(10) Pub. No.: US 2015/0257103 A1
(43) Pub. Date: Sep. 10, 2015

(54) METHOD AND DEVICE WITH AN AUGMENTED RULES ENGINE

(71) Applicant: GOOGLE TECHNOLOGY HOLDINGS LLC, Mountain View, CA (US)

(72) Inventors: Craig J. Detter, Gurnee, IL (US); Vignesh M. Karthik, TamilNadu (IN); Krishnan Raghavan, Karnataka (IN)

(21) Appl. No.: 14/432,087

(22) PCT Filed: Sep. 10, 2013
(86) PCT No.: PCT/US2013/058859

§ 371 Date: Mar. 27, 2015

(30) Foreign Application Priority Data
Sep. 27, 2012 (IN) 1119/KOL/2012

(51) Int. Cl. H04W 52/02

(52) U.S. Cl. CPC H04W 52/0229; H04W 52/0258; H04W 52/0254

(57) ABSTRACT

A device (200) and method (300) with an augmented rules engine is disclosed. The method (300) can include: providing (310) a power saving rule including a set of preconditions to be met, each precondition having a test procedure and an associated resource cost, the resource cost comprises power drain; executing (320) each precondition test procedure in a predetermined serial order starting with a lowest resource cost to a highest resource cost; discontinuing (330) a test procedure and disabling the power saving rule in the event a precondition is not met; and continuing (340) execution of a next precondition test procedure according to the predetermined order. Advantageously, the device (200) and method (300) can help to extend battery life, reduce latency and reduce receipt of unnecessary data.

### BACKGROUND

1. Field

The present disclosure relates to a method and device with an augmented rules engine.

2. Introduction

There is a need for enabling effective and reliable power management for wireless communication devices.

One of the more important design challenges in wireless communication devices is maximizing battery life and managing power use. Now that “wireless mobility and connectivity” has become a major user expectation, users demand power longevity in such devices. As more and more features, computing power, and memory are packed into wireless communication devices, there is a need for enhanced functionality in such devices, with satisfactory battery life.

There is also need to reduce the amount of power a circuit consumes and techniques to effectively manage the available power using on-device techniques, intelligent and efficient software, circuits and sensors.

Thus, there is a need for improving, customizing and better managing battery life in electronic devices.

It would be considered an improvement in the art, if a wireless communication method and electronic devices with enhanced power management were developed.

Thus, a method and device with intelligent or customized power management that addresses these needs, would be considered an improvement in the art.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system according to one embodiment.

FIG. 2 is an exemplary block diagram of a wireless communication device with an augmented rules engine according to one embodiment.

FIG. 3 is an exemplary block diagram of a wireless communication method with an augmented rules engine according to one embodiment.

FIG. 4 is an exemplary perspective view of a wireless communication device with Smart Actions on a display and a graph of power versus time for an augmented rules engine according to one embodiment.

### DETAILED DESCRIPTION

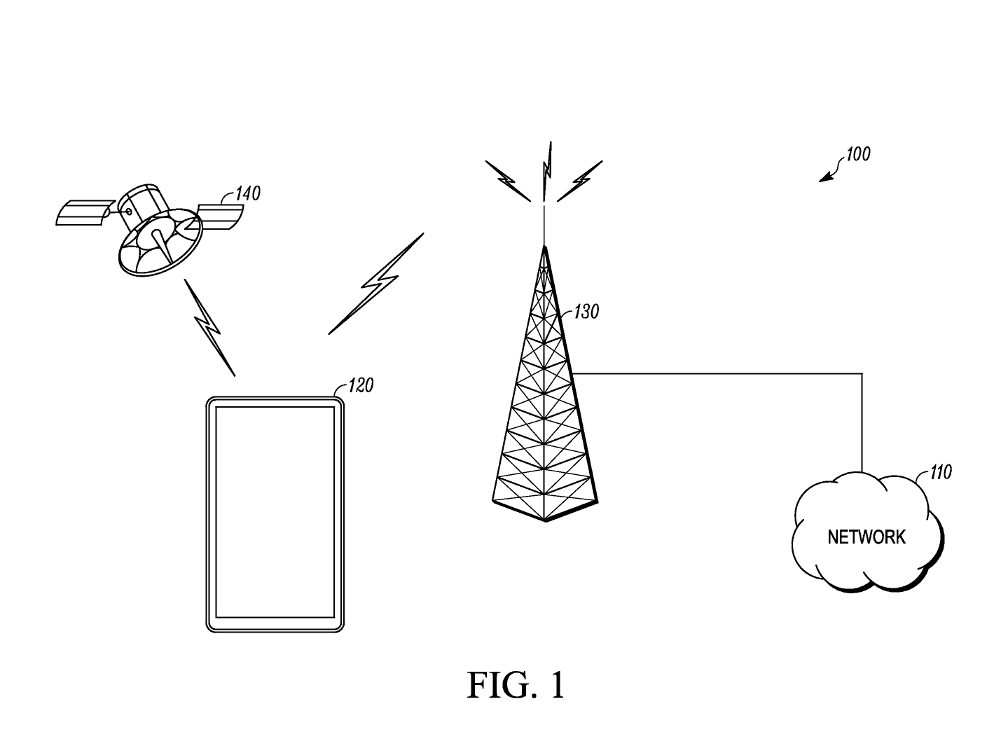

FIG. 1 is an exemplary block diagram of a system 100 according to one embodiment. The system 100 can include a network 110, a terminal 120, and a base station 130. The terminal 120 may be a wireless communication device, such as a wireless telephone, a wearable device, a cellular telephone, a personal digital assistant, a pager, a personal computer, a tablet, a selective call receiver, or any other device that is capable of sending and receiving communication signals on a network including a wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, Global System for Mobile Communications (GSM), a Third Generation (3G) network, a Fourth Generation (4G) network, a satellite communications network, and other like communications systems. More generally, network 110 may include a Wide Area Network (WAN), a Local Area Network (LAN) and/or a Personal Area Network (PAN). Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can include a wireless communication device and/or a wearable device 125 connected as an accessory or as stand alone devices, which communicate with the network 110 and with other devices on the network 110 by sending and receiving wireless signals via the base station 130, which may also comprise local area, and/or personal area access points, as detailed more fully herein. The terminal 120 is shown being in communication with a global positioning system (GPS) 140 satellite, global navigation satellite system (GNSS) or the like, for position sensing and determination.

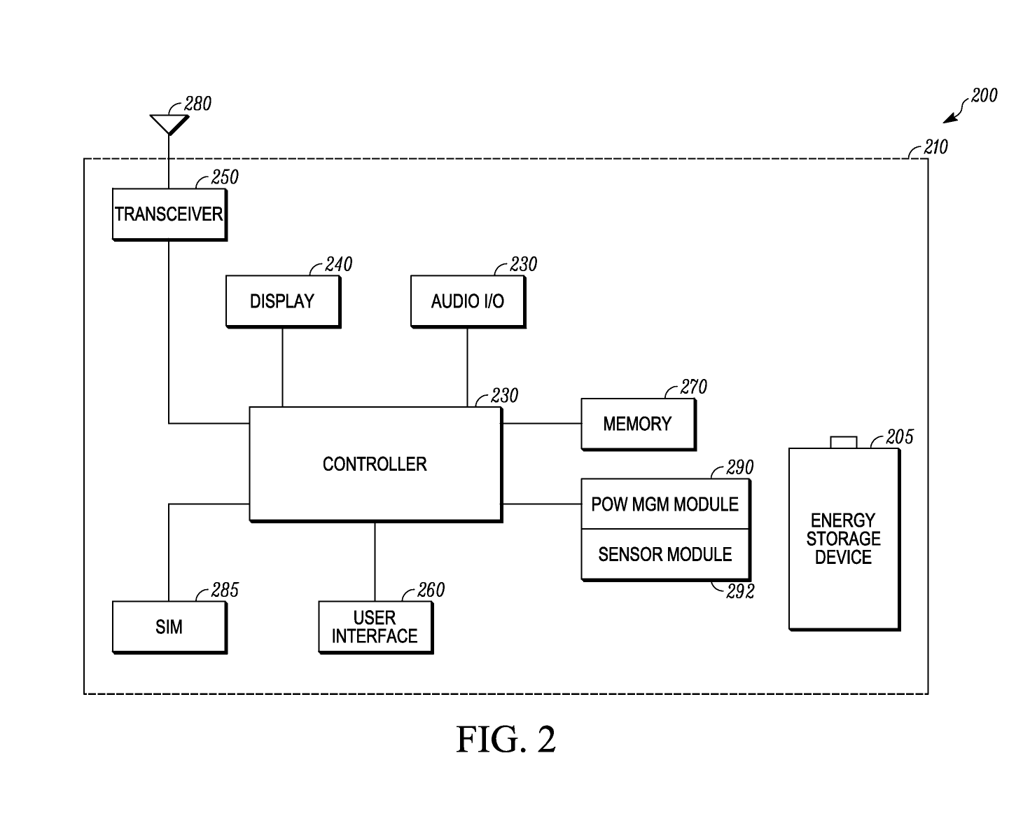

FIG. 2 is an exemplary block diagram of a wireless communication device 200 configured with an energy storage device, battery or module 205, such as in the terminal 120, for example. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module 285 coupled to the controller 220. As shown in FIG. 2, the wireless communication device 200 further includes a power management module 290 and sensor module 292, as described in more detail below. In one embodiment, the module 290 can reside within in the controller 220, can reside within the memory 270, can be an autonomous module, can be software, can be hardware, or can be in any other format useful for a module on a wireless communication device 200.

The display 240 can be a liquid crystal display (LCD), a light emitting diode (LED) display, a plasma display, a touch screen display or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch screen or pad, a joystick, an additional display, or any other device useful for providing an interface between a user and an electronic device. The memory 270 may include a random access memory, a read only memory, an optical memory or any other memory that can be coupled to a wireless communication device.

In more detail, the wireless communication device 200 shown in FIG. 2, can include: a housing 210; a controller 220 coupled to the housing 210, the controller 220 configured to control the operations of the wireless communication device and a power management module 290. The power management module 290 can augment the functioning of a device, better manage power consumption and better manage a user's affairs in an automated manner, as detailed herein.

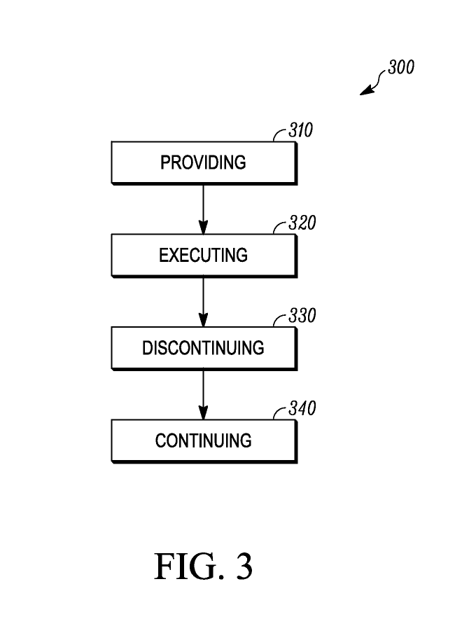

A block diagram of a wireless communication method with augmented rules engine 300, is shown in FIG. 3. In its simplest form, the method 300 can include: providing 310 a power saving rule including a set of preconditions to be met, each precondition having a test procedure and an associated resource cost, the resource cost comprises power drain; executing 320 each precondition test procedure in a predetermined serial order starting with a lowest resource cost to a highest resource cost; discontinuing 330 a test procedure and disabling the power saving rule in the event a precondition is not met; and continuing 340 execution of a next precondition test procedure according to the predetermined order. Advantageously, this can provide a power savings approach to evaluating preconditions for a rules engine.

Advantageously, the method can be used in connection with a wireless communication device to extend battery life. If all the preconditions of the power savings rule are not met, the method is discontinued, saving unnecessary power drain.

In more detail, in one embodiment, the rules engine only attempts to evaluate the lowest power-consuming preconditions first, then the next lowest, and so forth. This sequence can help to minimize power drain and battery consumption, because evaluating in this order (from lowest power drain to highest), provides the possibility of immediate stoppage or discontinuance in the event of a failure, thus preventing further unnecessary and unproductive power drain in the next higher power precondition in the sequence.

This can stop unnecessary power drain, because a subsequent evaluation of a next high power precondition is unnecessary since a failure has occurred.

In one embodiment, the method further includes an enabling step to enable a pass signal. This can provide a signal to allow or enable normal operations to occur or continue, for example. In more detail, the pass signal can indicate that all the preconditions of the power saving rule have been met and that an action is in a condition to be enabled or is enabled. Advantageously, providing a pass signal allows normal operation to occur, such as an immediate execution of an action, launch of an application, etc. In the event of failure, a device with an action will not be in a condition to enable an action, launch an application, etc. and an action will not be enabled.

In one embodiment, each precondition can be rated, weighted or tagged indicating relative power drain. That is, for example, each can be tagged as: high, medium or low power drain. The lowest power drain preconditions are evaluated first, followed by the medium, and then the highest. This avoids starting the evaluation of the highest current draining tasks until absolutely necessary, thus minimizing overall current drain.

This is an improvement over evaluating all preconditions simultaneously in a Rules Engine, which requires more power drain. That is, some preconditions may consume a lot of battery power to determine, such as when GPS is to be enabled, whereas others may require little power drain.

In one use case, the method 300 includes providing a wireless communication device including an energy storage device. The method 300 can help to prolong battery life.

In one embodiment, the method 300 includes checking whether or not to trigger the power saving rule. This feature can be done periodically, in a timed or set fashion, based on a sensor signal and the like, as detailed herein.

In one arrangement, the method 300 includes sensing a condition relating to a wireless communication device with the power saving rule. For example, a sensor could sense that a wireless communication device is docked, being charged or otherwise has a high battery charge of above 70%, and in such an instance power conservation may not be as much of a concern as compared to when a battery powered wireless communication device with has a low charge remaining.

The method 300 can include a heuristic algorithm that collects historical user data, for enhanced power savings and simplified customizing. For example, the method 300 can include providing a program which includes a heuristic algorithm that collects historical user data, so that such information can be used to configure the wireless communication device's functionality based on the collected historical user data. Thus, the device can learn a user's behavior and act on it, provide tips, provide optimal applications and functions, when desired and the like.

In another example, the heuristic algorithm can keep track of the actual power drain, real time, associated with evaluating a particular precondition, same with data (average data usage) and with latency. This tracked information and use history can be used in the future, to determine the best ordering, rather that using pre-assigned values (which may come from 3rd party sources). For example, the precondition may be rated high, low, low for power, data, and latency , respectively. However, heuristics, as evidenced by actual previous usage, may show that it's actually medium, medium, low, respectively. In this case, the precondition evaluation could be reordered accordingly by the use of heuristics.

In one embodiment, the method 300 can allow a user to program a wireless communication device with smart actions and/or a rules engine, the program is loadable, upgradeable, customizable and can be an application, that can help a user to better manage and/or automate a device.

In connection with the “resource cost”, the resource cost can include not only a power measure, such as power drain as previously detailed, it can include a latency measure and a data measure.

In one embodiment, the resource cost includes a latency measure, such as a delay or unit of time, and the executing step includes executing a lowest latency measure followed by a next lowest latency measure.

As previously stated, power, latency and data can be weighted and/or prioritized depending on the situation. In one arrangement, a rules engine can first prioritize power consumption, preferring low power first, followed by higher power. Next, if the power is equal, then the data consumption could be evaluated second, preferring low data consumption first, followed by higher data consumption.

One algorithm in the rules engine, can consider latency in parallel with power and data consumption. That is, if the device 400 is plugged into external power, then the high power consumption, high latency preconditions would be evaluated first, in order to give the user the optimal experience of the rule activating as quickly as possible. However, if the device is on battery power and the device has a low-battery state (low charge remaining), the rules engine would evaluate the high-power, high latency last, whereas if the battery charge remaining is high, the rules engine would evaluate high latency, high power preconditions earlier in the priority stack to provide the best user experience, just as if it were plugged into external power.

Similarly, in another example, if the data usage is high, and the consumer has an unlimited data plan, or has a higher percentage of data remaining (respectively, budgeting a linear data plan usage over the billing cycle month, for example), then the rules engine may determine that high latency, high data plan would be evaluated earlier in the priority sequence. Conversely, if the data plan is limited, and the user is over budget for the month so far, then the high data plan, high latency rules would be evaluated last in the priority stack.

In another embodiment, the resource cost could include a data measure, and the executing step includes a lowest data measure followed by a next lowest data measure. For example, the less data the less power would be required to down load than in a higher data measure or example.

In yet another embodiment, the resource cost could include a power measure, a latency measure and a data measure, and each measure is given a weight. So in this case, if a battery is connected to a charger, the power measure weight could be lower than one of the other measures. In a case where a user has a data plan, a data measure could have a high weight because the user would want to avoid going over his monthly data allotment. In a preferred embodiment, the method 300 can include sensing that a wireless communication device being docked or charged, and providing a low weight to the power measure in such a condition. As should be understood, this can include a dock, USB connection, a wirelessly charging connection and the like.

In more detail, the sensing step can determine that a device is connected to a user's home WiFi or an Ethernet cable connection, and in such case the latency measure could be given a lower weight and the data component could also be low, as data can be considered essentially free at home when connected to WiFi or an Ethernet cable.

In contrast, when a user is connected to a provider network, such as Verizon or ATT network, the user may be on a monthly data plan with a defined allotment, and once reached he or she must pay for extra data. In this case, the data component can be more heavily weighted with a goal of lowering the use of data when in a plan.

The term latency has its common ordinary definition in the field, and can be a measure of time. Users desire fast execution of there devices over slow. For example, a high-latency rule precondition can include a cellular data connection between a mobile device to a remote server or remote peer (another mobile device), which requires data transmission between the remote and local device to converge the remote state to a local device, where the connection may be at times unreliable, and therefore could take in the order of minutes, or more, to converge states between a remote device and a local device. An example of a medium-latency rule precondition can include a connection to a Bluetooth (BT) device. A wireless headset for example, may take several seconds to connect, even if it is nearby. The connection may or may not exist, but a determination of the existence of a connection is reliable and will typically take a number of seconds, for example, once a BT scan is started. An example of a low-latency rule precondition may be a local operation such as a headset being plugged into a device, which the state of “plugged in” (or not) is recognized typically within milliseconds, reliably, every time.

In one embodiment, a wireless communication device 200 with augmented rules engine is shown in FIG. 2. The device 200 can include: a housing 210; a controller 230 coupled to the housing 210, the controller 230 configured to control the operations of a wireless communication device; and a power management module 290 configured to: provide a power saving rule including a set of preconditions to be met, each precondition having a test procedure and an associated resource cost, the resource cost comprises power drain; execute each precondition test procedure in a predetermined serial order starting with a lowest resource cost to a highest resource cost; discontinue a test procedure and disable the power saving rule in the event a precondition is not met; continue execution of a next precondition test procedure according to the predetermined order; and enable a power saving pass signal if all the preconditions are met. Advantageously, the power management module 290 can help to improve the functioning of a device, better manage power consumption and better manage a user's affairs in an automated fashion.

The power management module 290 can be configured to check whether or not to trigger the power saving rule, periodically, in a timed manner, before an event or action is to occur, can be triggered by a sensor signal and the like.

In one embodiment, the device 200 can include a sensor module 292 configured to sense a condition relating to a wireless communication device configured with the power saving rule. The sensor module 292 can vary, and can include a plurality of sensors to sense a wireless connection, such as WiFi, 3G, 4G, or GSM connection, NFC connection, Bluetooth connection, a wired connection, dock or charger connection, battery level, location, movement and the like. Having this information can allow the device to work more intelligently and help to conserve power. A heuristic predictive algorithm that considers the above sensed information or typical user behavior, can help to predict, provide tips to a user, and facilitate the operation of a device, based on a users previous usage, for example.

In one embodiment, the power management module 290 is configured with a heuristic algorithm, such as a heuristic predictive algorithm that collects, stores and aggregates historical information. In one embodiment, the power management module 290 includes a program that can include predicting typical future user activity, based on historical information, such as user activity or usage stored in memory. Advantageously, a user can then take appropriate measures, such as immediately recharge a battery, take power reduction action and the like, when appropriate.

In one embodiment, the heuristic predictive algorithm collects and stores user activity or usage information. Correlating user activity can allow the program to learn and predict a user's typical usage and behavioral habits, based on the collected, stored and aggregated user behavior. Advantageously, this information can help a user manage the functioning of a device, better manage power consumption and better manage a user's affairs in an automated manner.

The user may initially indicate a certain profile that they feel is indicative of their expected usage. This can be used by the device while history is gathered to personalize the usage predictions. Advantageously, a heuristic algorithm can allow a device to work more intelligently and provide usage tips and predictions.

In one embodiment, the resource cost can include a power measure, a latency measure and a data measure, and wherein each of the measures are weighted. Weighting each measure can provide a more efficient rules engine.

In a preferred embodiment, the power management module 290 is configured to interact with a user interface 260, such as a touch screen display, to provide simplified user operation.

In one embodiment, the power management module 290 is configured to control a user interface to display and program smart actions. In one case, the power management module 290 can detect how much life the energy storage device has remaining before needing to be recharged, based on the functionality presently set. The power management module 290 can include an action to utilize this information to automatically turn off segments or functions of the device.

The power management module 290 can also include actions to minimize power drain, such as when a battery has reached a threshold remaining level, disable data; enable airplane mode; reduce display brightness; restrict application processor speed; reduce an application update rate; enable and disable wireless connectivity, such as WiFi and Bluetooth; enable and disable location tracking and disable an application or segment of a device. As should be understood, other actions are possible.

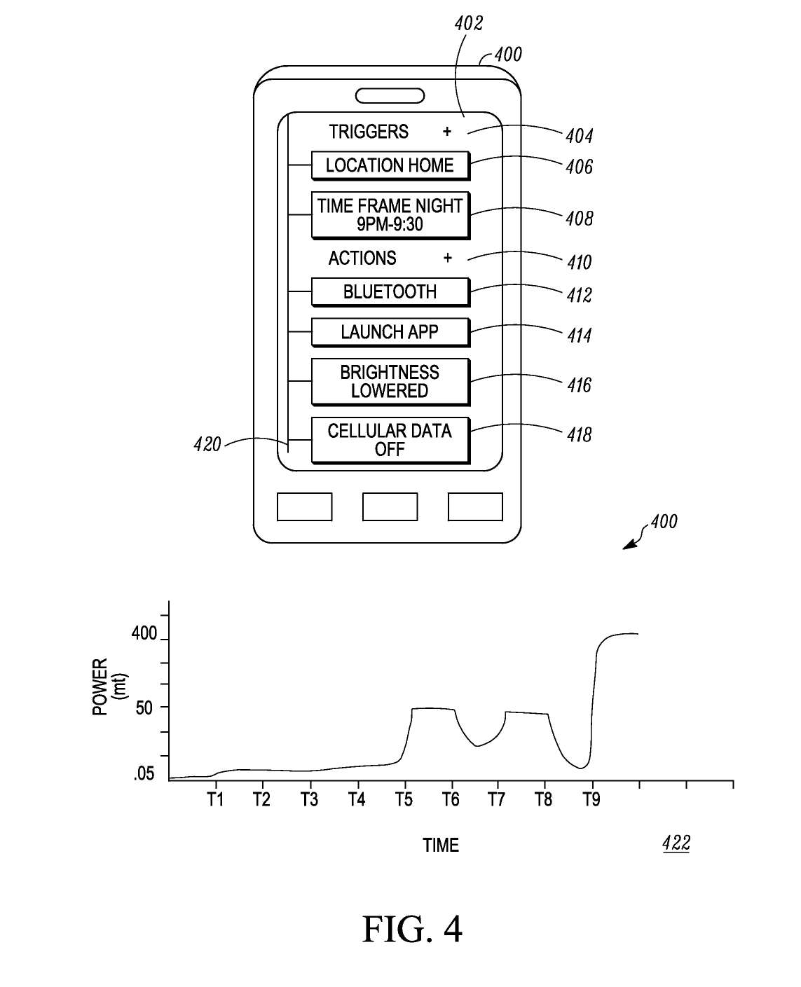

FIG. 4 provides a drawing and an example of a rule engine and an Application (App) called Smart Actions, which is particularly adapted for use with wireless communication devices, such as smart phones and tablets. Smart Actions allows a user to optimize a wireless communication device for a user's busy life. A user can spend less time managing a device and more time enjoying it. It can provide substantial power improvements in battery life. And, it can provide peace of mind with settings that let a user do things like automatically send a text to certain missed callers.

In brief, whether a user wants to maximize a device's last ounce of power, or prevent a phone from ringing during a meeting, Smart Actions can help. It works by automatically triggering specific actions, based on things like time of day, location, battery levels and more. With this App, life can be easier.

The Smart Actions App can be factory installed, downloaded and the like.

The App is intuitive. It recognizes what a user does on his or her phone and makes suggestions for new rules, to maintain control of a user's day. Of course, a user knows best, so the user can always create a Smart Action from scratch, or customize the suggestions that come with the App.

The App can help to maximize a battery. Thus, the chances of getting through the day on a single charge, is enhanced, by setting up Smart Actions that help conserve battery. With battery saving Smart Actions in place, as the battery charge winds down, a user's settings can adjust, for example, by diming the display, slowing data usage, and turning of certain segments, to make the most of what's left.

The App allows a user to automate his or her phone, by setting triggers and actions. In FIG. 4, the App is programmed for night time radio.

Referring to FIG. 4, the wireless communication device 400 includes a display 402, such as a touch screen display, with triggers 404 and actions 410. The triggers 404 include a location 406, such as home, and a timeframe 408 set at 9 pm. The user has set the actions 410 to include Bluetooth 412, launch an App 414, brightness has been lowered 416 and cellular data 418 has been turn off. This has been set for a user's night time radio. A pipe 420 indicates this program. Thus, at 9 am a user has set a download of certain podcasts for playback on a speaker via Bluetooth. Thus, in this example, Bluetooth is automatically connected to a user's speakers or ear phones and a Dog Catcher App is used to download a user's selected feeds to be downloaded. The brightness setting is dimmed so as not to irritate a user's eyes at night and cellular data is turned off. In this example, the user's home WiFi is on, so cellular data is not needed.

In FIG. 4, the Rules Engine can include a rule comprised of two preconditions, namely time and location. Sensing the time is a low-power, low latency, low-data plan usage precondition. Therefore, it is evaluated first. Sensing location on the other hand may require the device to turn on GPS, and therefore makes it a high power consumption precondition, as well as either high or medium latency (GPS may not work at all indoor locations, but may use WiFi to sense location instead indoors, therefore it is a medium power, medium latency). Therefore, in FIG. 4, the location sensing will be evaluated second because of the high to medium power, and high to medium latency. It is noted that the actions are of no consequence to the rules engine, as they have to occur whether they are high or low in power consumption.

The device 400 in FIG. 4 is provided or configured with a power saving rule including a set of preconditions to be met, each precondition having a test procedure and an associated resource cost, the resource cost comprises power drain.

The graph 422 in FIG. 4 includes a vertical axis of power and a horizontal axis of time. The device 400 is initially in an idle or sleep mode, and at T1 a wake up signal is triggered drawing minimal power.

At T2, a wake up signal for Smart Actions is triggered. A state machine can change an evaluate rule.

At T3, a rules engine signal is triggered to begin (Executing Step 320). If there is no error in a pre-condition, the discontinue step 330 is not triggered. In the event there is a pre-condition error, the test procedure would be discontinued and the power saving rule would be disabled and an action would not occur.

At T4, an evaluate location signal is triggered (Continuing Step 340). This is a next lowest low power activity. According to the Continuing Step 340, here the continuing execution of a next precondition test procedure according to the predetermined order is done. If there is no error in the pre-condition, the discontinue step 330 is not triggered.

Thus, all preconditions have been met, and actions can now occur.

At T5, a start sensing location state signal is triggered. For example, this could sense WiFi or GPS at a home location. In this example, a WiFi signal is sensed only drawing about 50 mA of current.

At T6, a home location is sensed.

In this example, a motion sensor is included in device 400. At T7, a motion sensing scan is triggered for a certain time, for example 5 minutes, because a user has moved the device 400. At T8, the motion sensing scan ends, as the scan window has closed, and there is presently no need to further track location.

At T9, playback is initiated by user.

Advantageously, if all preconditions have been met actions can now occur, such as launching an application, playing back a download, etc. If not, the rules engine would discontinue and an action would not occur and an app would not be launched.

The device 200 and method 300 are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.

We claim:

1. A wireless communication method with augmented rules engine, comprising:
providing a power saving rule including a set of preconditions to be met, each precondition having a test procedure and an associated resource cost, the resource cost comprises power drain;
executing each precondition test procedure in a predetermined serial order starting with a lowest resource cost to a highest resource cost;
discontinuing a test procedure and disabling the power saving rule in the event a precondition is not met; and
continuing execution of a next precondition test procedure according to the predetermined order.

2. The wireless communication method of claim 1, further comprising providing a wireless communication device including an energy storage device.

3. The wireless communication method of claim 1, further comprising checking whether or not to trigger the power saving rule.

4. The wireless communication method of claim 1, further comprising sensing a condition relating to a wireless communication device with the power saving rule.

5. The wireless communication method of claim 1, further comprising providing a program which includes a heuristic algorithm to allow a user to program a wireless communication device based on collected historical user data.

6. The wireless communication method of claim 1, further comprising allowing a user to program a wireless communication device with smart actions.

7. The wireless communication method of claim 1, further comprising allowing a user to program a wireless communication device with smart actions, wherein the smart module is loadable, upgradeable and customizable.

8. The wireless communication method of claim 1, wherein the resource cost further includes a latency measure and a data measure.

9. The wireless communication method of claim 1, wherein the resource cost includes a latency measure, and the executing step includes executing a lowest latency measure followed by a next lowest latency measure.

10. The wireless communication method of claim 1, wherein the resource cost includes a data measure, and the executing step includes a lowest data measure followed by a next lowest data measure.

11. The wireless communication method of claim 1, wherein the resource cost further includes a power measure, a latency measure and a data measure, and each measure is given a weight.

12. The wireless communication method of claim 11, further comprising sensing that a wireless communication device is docked or being charged, and providing a low weight to the power drain resource cost when in a docked or charging condition.

13. The wireless communication method of claim 11, further comprising enabling step includes enabling a signal that all the preconditions of the power saving rule have been met

14. The wireless communication method of claim 11, wherein the enabling step includes providing a signal that all the preconditions of the power saving rule have been met and that an action is enabled.

15. A wireless communication device with augmented rules engine, comprising:
a housing;
a controller coupled to the housing, the controller configured to control the operations of a wireless communication device; and
a power management module configured to: provide a power saving rule including a set of preconditions to be met, each precondition having a test procedure and an associated resource cost, the resource cost comprises power drain; execute each precondition test procedure in a predetermined serial order starting with a lowest resource cost to a highest resource cost; discontinue a test procedure and disable the power saving rule in the event a precondition is not met; continue execution of a next precondition test procedure according to the predetermined order; and enable a power saving pass signal if all the preconditions are met.

16. The wireless communication device of claim 15, wherein the power management module is configured to check whether or not to trigger the power saving rule.

17. The wireless communication device of claim 15, further comprising a sensor configured to sense a condition relating to a wireless communication device configured with the power saving rule.

18. The wireless communication device of claim 15, wherein the power management module is configured with a heuristic algorithm.

19. The wireless communication device of claim 15, wherein the resource cost further includes a latency measure and a data measure, and wherein each of the measures including the power measure, the latency measure and the data measure are weighted.

20. The wireless communication device of claim 15, wherein the power management module is configured to interact with a user interface.
